(19) United States
(12) Patent Application Publication
(10) Pub. No.: US 2002/0022112 A1
(43) Pub. Date: Feb. 21, 2002

(54) Process for the production of multi-layer security products, and a security product produced in accordance with the process

(76) Inventors: Harald Hoeppner, Berlin (DE); Thomas Loer, Berlin (DE); Detlef Martens, Berlin (DE); Michael Radtke, Berlin (DE)

Correspondence Address: Shahan Islam, Rosenman & Colin LLP, 575 Madison Avenue, New York, NY, 10022, US

(21) Appl. No.: 09/938,957

(22) Filed: Aug. 24, 2001

Related U.S. Application Data
(63) Continuation of application No. PCT/EP00/00780, filed on Feb. 1, 2000.

(30) Foreign Application Priority Data
Feb. 24, 1999 (DE) 199 07 940.4

(51) Int. Cl. B32B 3/00; B29C 47/06

(52) U.S. Cl. 428/156; 428/195; 264/482; 264/132; 264/153; 264/171.13

(57) ABSTRACT

The invention relates to a process for the production of multi-layer security products and to a security product produced in accordance with the process. The process is distinguished by the fact that the various layers of the security product are produced substantially separately from one another as rolled materials and are provided with security features, and the individual rolled webs are led together and joined to one another in a common processing process. The security products produced in this way are laser-active and can therefore be personalized by means of a laser.

### BACKGROUND OF THE INVENTION

1. Field of the Invention

The invention relates to a continuous process for the production of multi-layer security products, and to a security product itself produced in accordance with the process.

2. Description of Related Art Including Information Disclosed Under 37 CFR 1.97 and 1.98

Security products include identification and security documents, such as personal identity cards, passports or drivers' licenses, bank cards and so on. It is also possible for any desired security documents and documents of value to be produced by the process according to the invention. Such security products have a large number of security features, such as iris printing and guilloches, security inks, mottled fibers, planchettes, security threads and holographic elements. In this case, these security features are applied in and/or onto a carrier material, such as paper or plastic. In addition, individual data, for example relating to the owner of the security product, can be provided in/entered on this carrier material.

The different layers of a security card made of plastic perform different tasks. Specific layers in the interior of the card serve as a carrier of printed information (protective guilloche underprinting, key texts and so on) and are, for example, designed to be opaque. Further layers can, for example, be doped with materials which permit the plastic material to be personalized by means of a laser (CO₂, Nd:YAG). Further layers can be added to these, which can bear additional printing features (security printing, UV-reactive printing and so on). A particularly durable, transparent plastic can be used as the lowest and topmost layer in order to protect the card.

The production of such security cards is very complicated and costly. First of all, the raw plastic material, produced and supplied in roll form (various plastics, mainly polycarbonates with specific properties) has to be divided up into sheets. The individual sheet is a carrier for a fixed number of blanks. Specific sheets have to be printed in accordance with their intended use (carrier of the protective printing, carrier of further security features). Then, the individual sheets must be guided over one another in exact register and fixed. The sheet layers put together in this way are joined/fused to one another in a laminating press, which has to be heated in a complicated manner and also cooled down again.

The card layer construction is concluded in this way. By means of a subsequent stamping operation, the individual card blanks are obtained, which are then available as finished card bodies for the subsequent process of personalization.

Because of the process, the output rate when laminating with presses of this type is relatively low. In addition, it is a drawback in the process from the prior art outlined above that, during the production of multi-layer security documents which are personalized by means of laser technology, there is a very high outlay on production.

In addition, in the case of such sheet materials, it is also relatively difficult to bring the various layers over one another and to join them to one another with accurate register.

In this regard, the prior art reveals EP-A-0 628 408, which describes a process for the production of security paper. In this case, first of all the substrate is printed with security features and then the substrate is laminated between two paper layers. The substrate layer therefore contains security features which are unalterably permanently introduced and which have been set up for a quite specific product line. Subsequent changes with respect to the features introduced are not possible, nor are they envisaged.

EP-A-0 453 131 likewise shows a process for the production of security paper with integrated authentification features. This process also uses a lamination process for production. The same criticism applies here as in the case of EP-A-0 628 408.

WO-A-98/56596 discloses a security document, for example in the form of a banknote, which is likewise produced from a coated material and has further transparent plastic layers. The magnetic watermark discussed in the document already points to the fact that unalterable security features are concerned, since watermarks of this type are always identical. The criticism quoted above therefore also applies to this document.

### BRIEF SUMMARY OF THE INVENTION

The invention is based on the object of proposing a multi-layer security product which has layers lying one above another in accurate register, which can each be equipped with security features, it being possible for security features to be introduced or applied during its production or else subsequently.

In order to achieve the object set, the invention is a multi-layered security product and a method for making the same, comprising a printable carrier material firmly joined to a plastic coating which is extruded onto the carrier material and which contains laser-active pigments and or covering film laminated onto the carrier material.

It is a significant feature of the invention that the security product is now no longer produced as a sheet material, but that the various layers of the security product are produced substantially separately from one another as rolled materials and that then in a common processing process, the various rolled webs are led together and laminated together.

In a first process step, the carrier material, which, for example, is a printable plastic material or paper, is drawn off a roll and fed to a first printing unit. In this case, it can be printed on one side or on both sides. It is then led through an extrusion-coating plant, where a single-sided or two-sided plastic coating is applied and is finally firmly joined to the printed carrier web by means of pressing and cooling rolls joined downstream. The coating applied in this way can consist on one or both sides of a laser-active plastic material which permits subsequent personalization with an Nd:YAG laser or other lasers.

The material coated in this way can then be fed to a further printing unit, in order then in turn to be wound up onto a roll.

After this first process step, the first coating of the carrier material, in a second process step, this coated carrier material, as rolled material, is subjected to a relatively complicated continuous printing process where a series of security features are applied.

After printing on one or both sides of this coated carrier material, the latter is in turn wound up onto a roll and moved into the next processing station.

In the third process step, the printed and coated carrier material drawn off the roll is then laminated on both sides with appropriate covering films or composite covering films.

In this case, the invention can provide for the covering films or composite covering films used for the lamination already to be provided previously with appropriate security features, that is to say the covering films or composite covering films can per se be printed or set to be laser-active.

The important factor is that, in a highly accurate lamination process, the rolled material of the printed and coated web of the carrier material is brought together with the web of covering film or composite covering film, which may be capable of laser treatment and partly also printed, and in this way a multi-layer, web-like element is produced.

This element, which is still present in web form, then has all the required features of the security document, that is to say the various layers have been joined one above another in accurate register.

Following the accurately registered lamination of these layers, the security product, still present as an endless material, is substantially finished. It is then stamped out to form individual blanks and can subsequently be subjected to still further processing steps for the introduction of security features. For example, surface embossing may be carried out and/or lasering into the element can be carried out, that is to say one or more security features can be lasered on any desired plane in the layer-like element.

In this case, the lasering is preferably carried out on the cards already stamped out and embossed. However, provision can also be made to carry out the lasering on the moving web, that is to say before the stamping operation.

The cards produced in this way are then stacked up.

The important factor in the case of the invention is that the card element to be produced comprises a multi-layer construction, and the carrier materials used and the other functional layers are used and processed as rolled material and, as a result, a continuous process is possible.

According to the invention, the individual card elements are produced as follows:

A carrier material (for example a security paper or a plastic or a combination of paper and plastic) in rolled form is suspended in the unwinder of an extrusion coating plant, provided with plastic on one side and/or two sides and wound up again. It is also possible to apply a plurality of thin plastic layers one after another. The individual plastic layers can have different properties (doped, layers sensitive to laser light, integrated security features/security materials and so on). In addition, it is possible to integrate a printing operation before and after the extrusion of the individual plastic layers. The carrier material processed in the way has, in this state, all the properties necessary for laser personalization. This carrier material can be provided with high-quality security printing (motifs, key texts, unprinted areas for example for the subsequent introduction of the photograph, and so on) in web-fed printing machines (rotary security presses).

The carrier material is divided up on the image side, by the printing procedure, into the subsequent individual blanks. After the printing procedure, the individual card blanks can be stamped out in a continuous process and, if desired, then provided with a protective laminate on both sides. The protective laminate can also be equipped as a multi-layer composite with integrated security features and doping suitable for laser inscription (laser engraving).

The production process described above, and the production of security products is possible since, in the processing stages, plastics and plastic combinations matched to the technology applied are used and, at the same time, permit simple processing in standardized processes (extrusion of plastics, equipping these plastics with materials [doping] which ensures inscription by means of a laser beam).

The plastics used for the card element are, for example, easily processed polyethylenes, polypropylenes, polyamide and so on and also PVC. For the external protection, foil composites made of polyethylene and polyester, for example, can be used, it being possible for these to be laminated on simply. The fact that each of these individual layers contains doping which is sensitive to specific laser wavelengths means that the personalization of the cards by means of laser technology is very reliable.

The blackening (imaging) is present via the thickness of the doped layer or layers of the document. In addition, it is possible to set the doping of the layers in such a way that these react to different laser wavelengths. For example, it is possible for there to be layers which react to an Nd:Yag laser and layers which, for example, react to a CO₂ laser. Colored embodiments of lasered data (image and text data) are also possible in this way.

The inventive subject of the present invention results not only from the subject of the individual patent claims but also from the combination of the individual patent claims with one another. All the statements and features disclosed in the documents, including the abstract, in particular the physical design represented in the drawings, are claimed as essential to the invention, to the extent that, individually or in combination, they are novel as compared with the prior art.

In the following text, the invention will be explained in more detail using drawings, which illustrate only one implementation route. In this case, further significant features and advantages of the invention emerge from the drawings and their description.

### BRIEF DESCRIPTION OF SEVERAL VIEWS OF THE INVENTION

FIG. 1 shows, in schematic form, a first process step for the production of a coated carrier material;

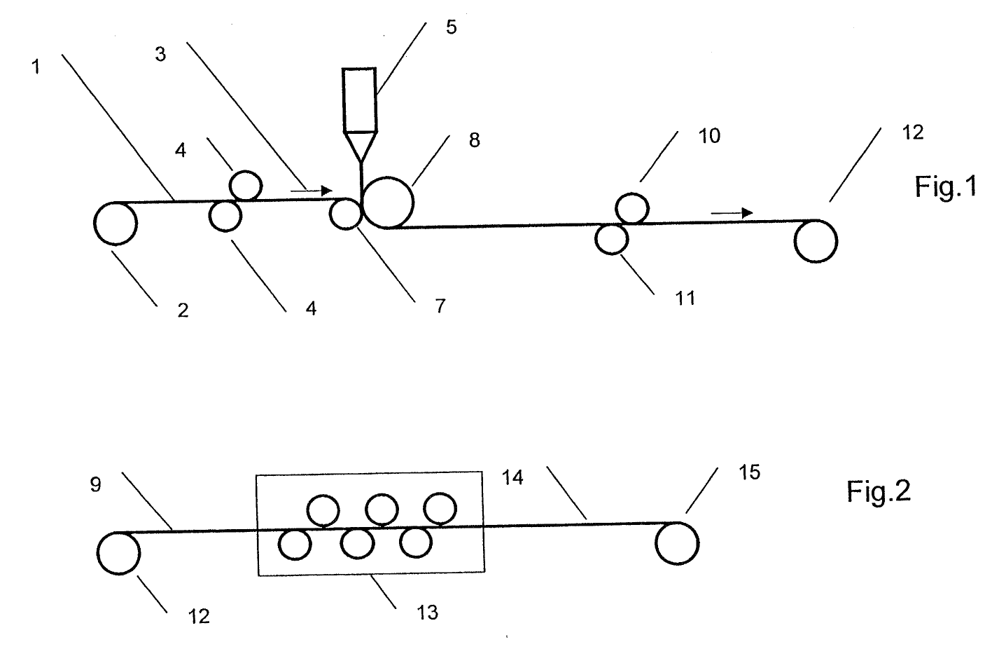

FIG. 2 shows the further processing of the carrier material which has been produced in accordance with FIG. 1;

FIG. 3 shows the final processing of the carrier material from the rolled material to the card material;

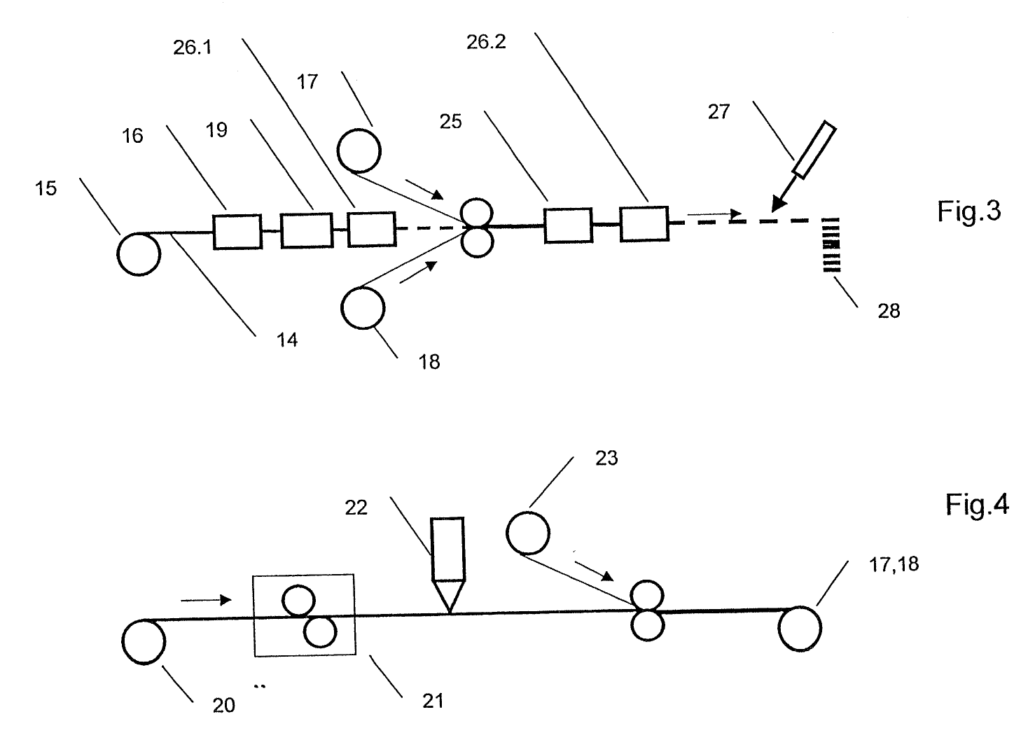

FIG. 4 shows an illustration of the production of composite covering film as an intermediate step.

### DETAILED DESCRIPTION OF THE INVENTION

In FIG. 1, a carrier material 1 is represented in general terms and preferably consists of a plastic material but which, however, can also consist of paper. This carrier material 1 is wound up onto a roll 2, which is drawn off in the direction of arrow 3. In this case, provision is then made in a first process step for one or both sides of the carrier material to be printed by a printing unit 4.

The carrier material printed on one or both sides is then fed to an extrusion coating plant 5, where a first plastic coating is applied in the form of an applied web 6 to the upper side and/or underside of the carrier material 1.

The carrier material 1, which has been coated in this way with a layer which is transparent, at least in a subarea, is then led through pressing roll 7 and through cooling roll (temperature-control roll) 8 in order to join the applied layer (plastic film) permanently to the carrier material. Here, provision can be made for the cooling roll to introduce embossing into the material of the applied web 6 as well.

The carrier material 9 coded in this way is then fed to the printing units 10 and 11, it being possible both for the upper side and for the underside to be printed. The coated carrier material 9 produced in this way is then wound up on the roll 12.

In the next process step according to FIG. 2, the roll 12 is again unwound in the direction of arrow 3, and the coated carrier material 9 is fed to a multiple printing unit 13, where a series of security features, such as guilloches, UV security features and the like, can be printed on. The coated and printed carrier material 14 produced in this way is then again wound up in the form of a roll 15.

FIG. 3 shows the third process step, in which the carrier material 14 is drawn off the roll 15 again and fed firstly to a device 16 for the introduction of further security features. This device 16 can contain a laser, for example, which carries out appropriate blackening (marking) in the layers of the coated and printed carrier material 14 which are already present. It is likewise possible for engraving or perforation to be carried out.

This is then followed by the application of an adhesion promoter 19, the stamping out of the individual blanks with the punch 26.1 and the lamination to an upper and lower covering film or composite covering film 17, 18. The carrier material 14 which has been coated, printed and stamped out as individual blanks is in this case enclosed by the laminate film from above and below and is permanently firmly joined to one another.

Before being stamped out, the laminated carrier material can be fed to an embossing station 25, where the surface of the covering laminate is embossed.

The security documents are therefore finished as an endless, laminated carrier material 24. They are then fed to a punch 26.2 and stamped out blank by blank as card-like documents.

The edges are then fed to a laser station 27, where further features can be burned in, the burning-in action not being restricted to the surface but it being possible for any desired layer in the multi-layer, laminated carrier material 24 to be reached by the laser. The cards produced in this way are then put into a magazine at the position 28.

The production of the composite covering films 17, 18 for the upper and lower covering laminates will be explained by using FIG. 4.

In this case, the first film web is unwound from the roll 20, fed to a printing unit 21 in the direction of the arrow and printed there with security colors on one or both sides. Then, in position 22, a lamination adhesive is applied to this film and the second film web from roll 23 is laminated on.

The advantage of the aforementioned measures is that the cards produced in this way have an extraordinarily high register accuracy, that they result in a good adhesive composite, since they have been laminated continuously as rolled materials, so that, during the lamination process, no problems arise in the edge regions, and so that they can be produced quickly and efficiently.

In particular, in the case of the process according to the invention, there is the advantage that it is a production process for documents which is as far as possible continuous. The individual materials used are used and processed as rolled materials, and therefore the continuous process as far as the separation of the blanks at the end of the process is ensured. The security product can therefore be built up efficiently from a plurality of individual layers with a safety function. The carrier material 1 used can be a paper web or a paper/plastic web, which can be produced particularly cost-effectively and, together with the composite covering films 17, 18, can be produced continuously and with accurate register to form a multi-layer composite.

As a result of the use of paper or paper/plastic composites, the use of subsequent security features, such as watermarks, planchettes, fluorescent visible and invisible fibers, is possible. This means that, for the first time, the possibility is offered of laminating paper-like carrier material with plastic covering films in accurate register in a particularly simple but highly accurate manner, by which means the advantages mentioned previously are achieved. In this case, the individual plastic layers can be set to be laser-active.

The cards produced in this way can then be personalized by using conventional laser systems, which was not possible hitherto. Here, personalization is understood to mean the introduction of personal features of the bearer into the finished document, specifically, for example, the introduction of the photograph, the introduction of the name, of the signature and of the ICAO lines.

While the preferred and alternate embodiments of the invention has been depicted in detail, modifications and adaptations may be made thereto, without departing from the spirit and scope of the claims as delineated in the following claims:

1. A multi-layer security product, comprising
a printable carrier material (1) firmly joined to at least one plastic coating which is extruded onto the carrier material and which contains laser-active pigments; and
at least one covering film (17, 18), laminated onto the carrier material.

2. The multi-layer security product of claim 1, wherein the laser-active pigments can be excited substantially by laser radiation of a specific wavelength.

3. The multi-layer security product of claim 1, wherein the carrier material is comprised of paper or plastic.

4. The multi-layer security product of claim 1, further comprising security features, such as watermarks and/or mottled fibers on the carrier material.

5. The multi-layer security product of claim 1, wherein the covering film contains laser-active pigments.

6. The multi-layer security product of claim 1, wherein the plastic coating has embossing.

7. The multi-layer security product of claim 1, wherein the plastic coating is printed.

8. A process for the production of multi-layer security products said process comprising the steps of:
providing a printable carrier material as a rolled material; a
extruding at least one plastic coating which contains laser-active pigments onto the carrier material; and
subsequently leading together highly accurately the carrier material with the plastic coating and (b) the covering film (17, 18).

9. The process of claim 8, wherein the carrier material with the plastic coating is rolled material and further providing the step of unwinding the rolled material after lamination.

10. The process of claim 8, further providing the step of stamping out individual blanks after the lamination with the covering film.

11. The process of claim 8, further providing the step of printing the carrier material in a single-stage or multi-stage process before the coating of the carrier material with the plastic coating

12. The process of claim 8, further providing the step of printing and/or embossing the plastic coating before the carrier material with the plastic coating is led together with the covering film and laminated.

13. The process of claim 8, wherein the carrier material comprises paper or plastic.

14. The process of claim 8, wherein the carrier material is equipped with security features, such as watermarks and/or mottled fibers.

15. The process of claim 8, wherein the covering film contains laser-active pigments.

16. The process of claims 8, wherein security features are produced in the plastic coating and/or the covering film by activating the laser-active pigments with laser radiation of specific wavelength matched to the laser-active pigment used.

17. The process of claim 16, wherein the security features produced by laser cannot at least to some extent, be personalized.

18. The process of claim 16, wherein the production of security features by laser in the plastic coating is carried out after the application of the plastic coating by extrusion and/or after the lamination of the at least one covering film.
